(19) United States
(12) Patent Application Publication
(10) Pub. No.: US 2006/0260474 A1
(43) Pub. Date: Nov. 23, 2006

(54) Kabob pan

(76) Inventor: Kenneth A. Tarlow, Corte Madera, CA (US)

Correspondence Address: KENNETH A. TARLOW, 21 GOLDEN HIND PSG., CORTE MADERA, CA, 94925, US

(21) Appl. No.: 11/131,236

(22) Filed: May 18, 2005

(51) Int. Cl. A47J 43/18

(52) U.S. Cl. 99/426

(57) ABSTRACT

Kabob cooking pan having a generally rectangular shaped bottom and integral side walls, a hollow pan handle and a pan to handle attaching means. A plurality of food retaining cylindrical cages each terminate at one end in a removable closure cap and at its opposite end in a fixed closure cap. The pan includes a plurality of integral side by side troughs coinciding with the diameter of each cylindrical cage. The cage end caps each include an integral centrally located shaft, one shaft being round in cross section and the other shaft being non round in cross section. Each non round shaft is retained by a similar shaped aperture in a drive pulley assembly housed within the hollow handle portion which is in turn engages a rotatable crank assembly so that the cages can be rotated by the turning of the crank.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of rangetop cooking pans and more specifically to a kabob pan.

Rangetop cooking pans are well known. They tend to be made of steel, iron or aluminum and may often include non-stick coatings. They are meant to be placed on top of an electric heating element or a gas burner. The making of kabobs is a process that normally takes place on a grill or in an oven. A kabob consists of placing a number of pieces of meat or fish or vegetables on a metal skewer which is then placed on a grill or in an oven.

More recently, metal cages have been marketed to replace the skewers to encapsulate the pieces of meat or vegetables. It is a common practice to brush a liquid marinade onto the kabob as it is being cooked.

Although the standard method of making kabobs is adequate, it does not allow a person to cook a kabob on a standard gas or electric rangetop. Current methods of making kabobs also do not allow easy continuous marinating of all sides of the kabob.

### BRIEF SUMMARY OF THE INVENTION

The primary object of the invention is to provide a rangetop cooking pan that includes a means to rotate a plurality of kabobs.

Another object of the invention is to provide a rangetop kabob pan that allows the user to turn a crank built into the pan's handle to cause the kabobs to rotate.

Another object of the invention is to provide a rangetop kabob pan that includes troughs for each kabob that can retain marinade so that as each kabob rotates, it is coated with marinade.

A further object of the invention is to provide an alternate rangetop kabob pan that includes a motor to turn the kabobs automatically.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a kabob pan comprising: a cooking pan having a rectangular shaped bottom and integral side walls, a hollow pan handle a handle to pan retaining means, a plurality of food retaining cylindrical cages, each said cage terminating at one end in a removable closure cap and at its opposite end in a fixed closure cap, said pan including a plurality of integral side by side troughs coinciding with and slightly larger than the diameter of each said cylindrical cage, said end caps each including an integral centrally located shaft, one shaft being round in cross section and the opposite shaft being non round such as hexagonal in cross section, each said hexagonal shaft capable of being removably retained by a hexagonal shaped aperture in a drive pulley assembly built into said hollow handle portion, said drive pulley mechanism being driven by a belt or chain and built into said hollow pan handle, said belt or chain capable of being driven by a rotatable crank assembly built onto said hollow pan handle, said wall that is opposite said pan handle having a plurality of vertical slots capable of removably retaining said round shafts of said closure cap, and said wall that is affixed to said handle having a plurality of apertures evenly spaced in relation to said cage shafts to allow said shafts to engage with said hexagonal apertures in said drive pulleys. An additional embodiment includes a gear reduced motor drive that engages the central shaft of the rotatable crank and causes the cylindrical kabob cages to rotate automatically.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the invention with the lid removed.

FIG. 3 is a perspective view of the invention with the top portion of the handle removed.

FIG. 4 is an exploded view of the food holding cylinder of the invention.

FIG. 5 is a partial side section view of the pan and lid portion of the invention.

FIG. 6 is a partial side section view of the handle portion of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

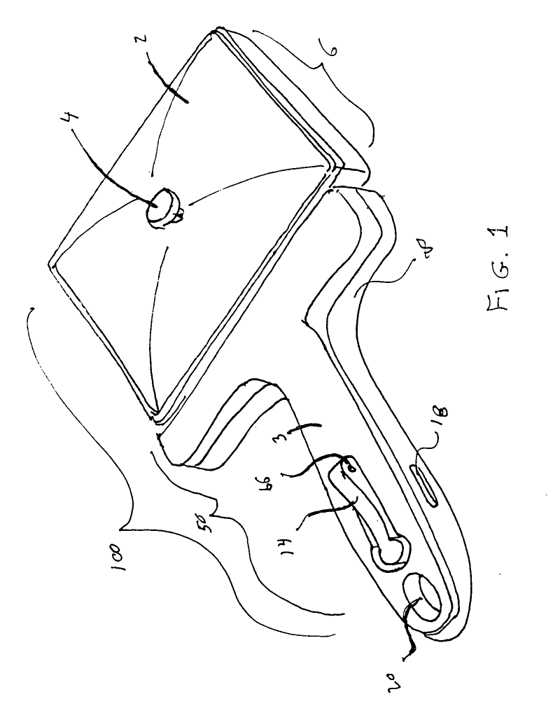

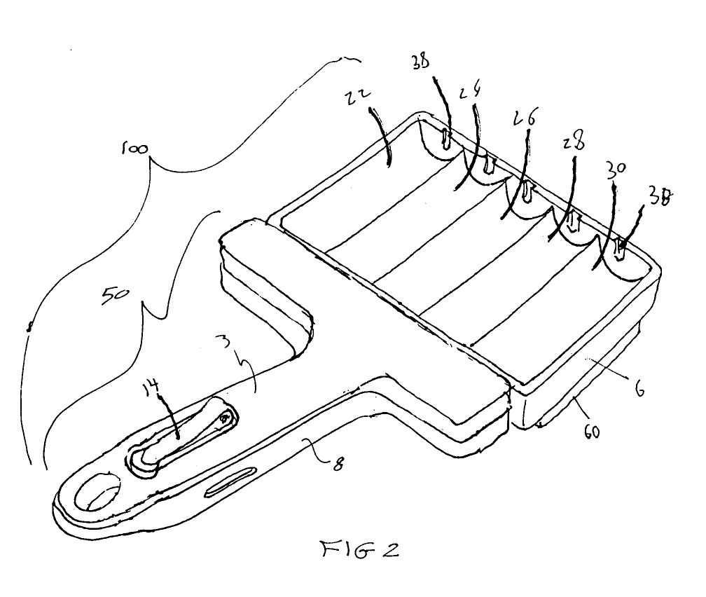

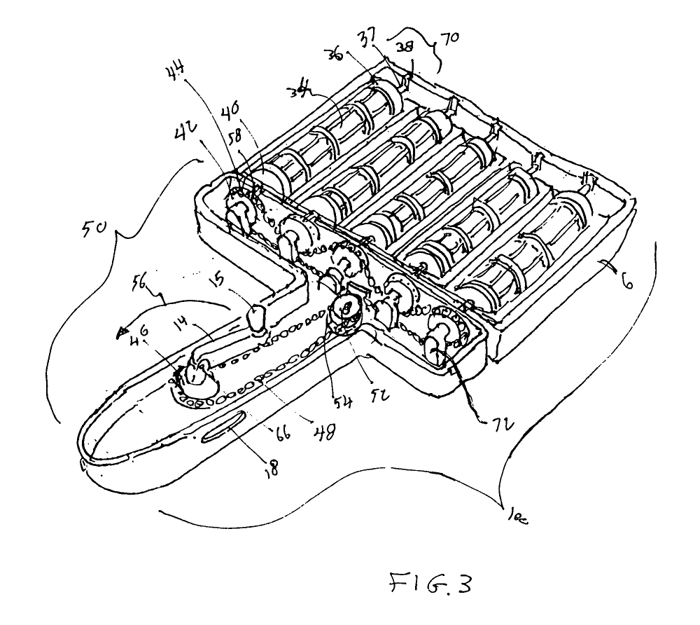

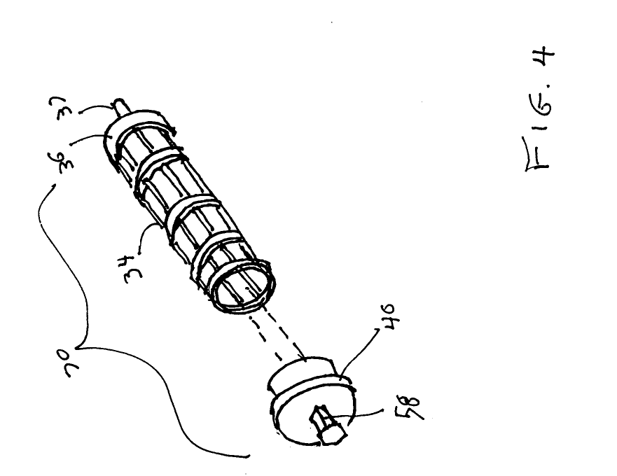

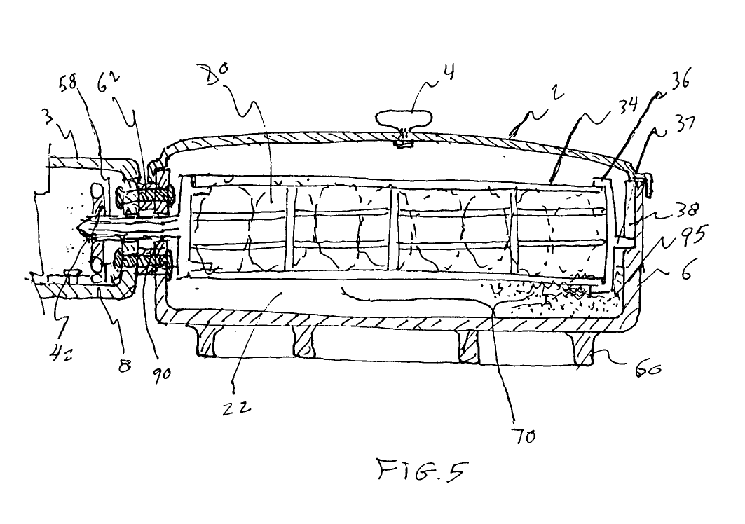

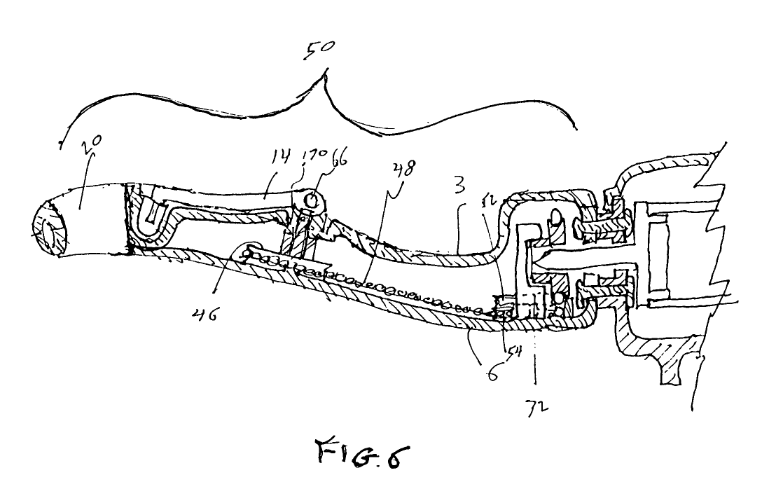

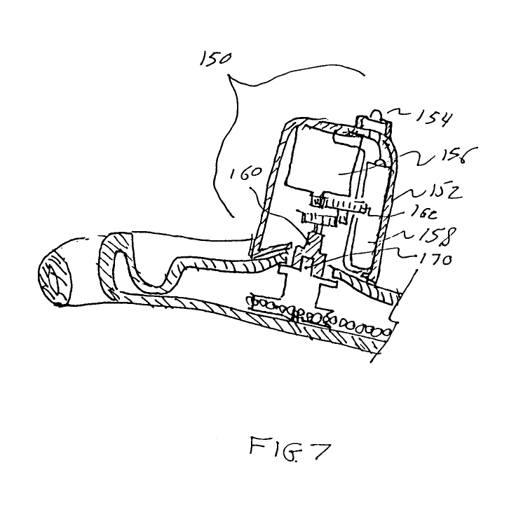

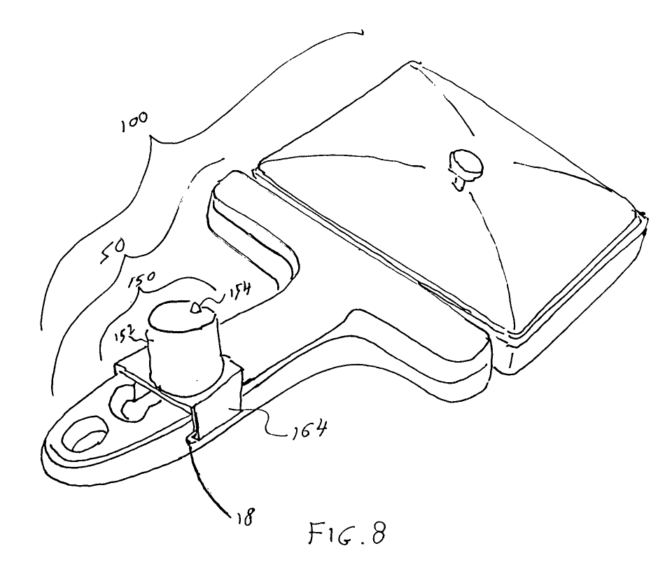

Referring now to FIG. 1 we see a perspective view of the kabob pan 100 of the present invention. This view shows the sidewalls of the pan portion 6, the lid 2 and attached knob 4, the handle assembly 50 including the top handle housing 3, bottom handle housing 8 and crank handle 14. Aperture 20 allows the pan to be hung on a standard pan rack. As can be seen, the pan 6 is generally rectangular in shape and has integral side walls. Hollow handle portion 50 is molded of high temperature plastic such as phenolic. Detent 18 allows a motor assembly to be attached to the handle. FIG. 2 shows a perspective view of the invention 100 with the lid removed. Pan 6 includes integral troughs 22, 24, 26, 28, 30 that correspond with, and are slightly larger in width than, the cylindrical food cages 70 shown in FIG. 4. The troughs are meant to retain marinating sauce. The cylindrical food cages 70 are inserted into the trough areas as shown in FIG. 3. The cage assembly has one fixed closed end 36 which includes a centrally located shaft 37 that fits into retaining slot 38. The opposite end of the cage 70 has a removable closure 40 that includes a centrally located hexagonal shaft 58 that can engage a pulley member 42. Any non round shaft configuration will work as long as the engaging aperture matches. It should be noted that a standard kabob skewer having similar outwardly facing shafts can be used in place of the described kabob cages. A ball chain or belt drive 44 engages each pulley in the assembly and then returns to itself in an endless loop. Another ball chain pulley 54, mounted horizontally, makes contact with the chain 44 and wraps around crank pulley 46. By turning crank handle 14 via crank knob 15, all five cylindrical food cages 70 are caused to rotate. In this way, when the troughs 22, 24, 26, 28, 30 are filled with marinade, the food retained in the cages 70 is dipped in the marinade. As each cage rotates, the food contained inside is evenly coated. The user can turn the crank handle 14 periodically during cooking to insure that the food remains coated with marinade as it cooks. The result is a superior kabob that is flavorful and moist. It should be noted that other standard mechanical translation methods can be used to turn kabob cages 70 such as gears, belts or other known linkages. FIG. 4 shows an exploded view of a cylindrical food cage 70. It is comprised of a cage body 34 made of metal mesh or welded metal wire, a fixed closed end 36 having a shaft with a round cross section 37 extending outward, and a removable end 40 having a hexagonal shaft 58 protruding outward. FIG. 5 shows a partial side section view of the pan where cylindrical cage 70 is in place within the pan 6. Round shaft 37 is slidably retained within slot 38. Hexagonal shaft 58 is engaged with a hexagonal aperture within pulley 42. Shaft 58 exits the pan 6 through aperture 90. Pan handle 50 is attached to pan 6 via rivets 62. Lid 2 holds heat in during cooking so that the pan acts like an oven. Marinade 95 is placed in trough 22 so that the food, as shown by dotted line 80 is dipped in the marinade 95. The food is evenly coated with marinade 95 as the food cage 70 is rotated. Optional downwardly facing ribs 60 help raise the handle bottom 8 so that it is not as exposed to the heat from a standard stove top than if there were no ribs. FIG. 6 shows a side section view of the handle portion 50 of the pan. Pulley holding brackets 72 can be clearly seen. Horizontal pulleys 52, 54 and 46 are shown. Together, these pulleys along with chain 48 transfer rotational forces initiated by crank handle 14 to the pulley assembly 42 and finally to the rotating food cages 70 located in the pan 6. FIG. 7 shows a partial side section view of the handle portion of the pan where the crank handle has been removed and in its place, a motorized assembly 150 has been mounted. Socket 160 engages shaft 170. Motor 156 is powered by battery 158 which can be activated by switch 154. Gear reduction assembly 162 reduces RPM's to the desired turning speed. FIG. 8 shows a perspective view of the pan 100 with the motor assembly 150 attached. Side walls 164 include an inwardly turned tab that engages with recess 18 located in the side of the pan handle 50. In this way, a person can rotate the kabobs automatically without the need for the user to be present.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. kabob pan comprising:
a cooking pan having a rectangular shaped bottom and integral side walls;
a hollow pan handle;
a pan to handle retaining means;
a plurality of food retaining cages;
each said cage terminating at one end in a removable closure cap and at its opposite end in a fixed closure cap;
said pan including a plurality of integral side by side integral troughs coinciding with each said cylindrical cage;
said end caps each including a centrally located outwardly facing shaft, one shaft being round in cross section and the other shaft being non round such as hexagonal in cross section;
each said hexagonal shaft capable of being removably retained by a hexagonal shaped aperture in a drive pulley assembly built into said hollow handle portion;
said drive pulley mechanism being driven by a belt or chain that is housed within said hollow pan handle;
said belt or chain capable of being driven by a rotatable crank assembly built onto said hollow pan handle;
said pan wall that is opposite said pan handle having a plurality of vertical slots capable of removably retaining said shafts of said closure cap; and
said pan wall that is affixed to said handle having a plurality of apertures evenly spaced in relation to said cage shafts to allow said shafts to engage with said hexagonal apertures in said drive pulleys.

2. Kabob pan as claimed in claim 1 wherein said crank assembly includes a centrally located hexagonal aperture that can accept a gear reduced motor drive or spring motor drive for rotating said cylindrical cages automatically.

3. Kabob pan as claimed in claim 1 wherein standard skewers can be substituted in place of said kabob cages.
